(19) United States
(12) Patent Application Publication
(10) Pub. No.: US 2011/0290124 A1
(43) Pub. Date: Dec. 1, 2011

(54) CITRUS PRESS

(76) Inventor: Mariko NIWA, Osaka (JP)

(21) Appl. No.: 13/114,404

(22) Filed: May 24, 2011

(30) Foreign Application Priority Data
May 25, 2010 (JP) 2010-119936

(51) Int. Cl. A23N 1/00

(52) U.S. Cl. 99/509

(57) ABSTRACT

The citrus press comprises a retaining base and a plurality of prongs arranged upright on one face of the retaining base, wherein a severing part is formed at least at the tip of each prong, for severing segment membranes of citrus fruit.

### TECHNICAL FIELD

The present invention relates to a citrus press, hereinafter also referred to as a “press.”

### BACKGROUND ART

Conventional citrus presses, which are used to squeeze the juice of citrus fruits such as lemons, limes and oranges include those proposed in JP-2001-204619-A and JP-3034332-U.

The citrus press described in JP-2001-204619-A comprises a saucer body formed with raised peripheral edges, and an upwardly oriented and conically shaped juicing part provided in the center of this saucer body. A plurality of longitudinal ribs are provided on the side wall of this juicing part, and a small flat area, or recessed area, is provided at the top of the juicing part.

The citrus press described in JP-3034332-U is made from a metallic material and comprises a bowl body, and a juicing part, which is provided upright in the central recess of the bowl body, having a substantially conically shaped external diameter, and being provided with a plurality of vertical grooves on the side surface thereof. The juicing part provides a volume corresponding to the fleshy portion of a large citrus fruit that has been cut in half, and pouring spouts are provided at two opposite positions on the peripheral edge of the bowl wall of the bowl body, while a separate handle is provided at another peripheral edge position.

When squeezing citrus juice using the citrus presses described in JP-2001-204619-A and JP-3034332-U, the citrus press is placed on a table or the like, the citrus fruit that has been cut in half is pressed onto the juicing part, and the citrus fruit is rotated while continuing to push, whereby the juice is squeezed out of the citrus fruit and collects in the saucer body or bowl body.

Thereafter, by tilting the saucer body or the bowl body, the juice can be poured to a desired location.

However, with the citrus presses described in JP-2001-204619-A and JP-3034332-U, because the juicing part is bigger than a citrus fruit that has been cut in half, a large force is required in order to push the citrus fruit onto the juicing part and squeeze the juice.

Furthermore, because the segment membrane of the citrus fruit is crushed with brute force, it is not possible to optimize production of juice in the juicing operation.

If, in light of this problem, a citrus fruit that has been cut in half is pressed onto the juicing part with brute force and rotated with this brute force applied, in order to increase the amount of juice that can be obtained in the juicing operation, bitter components from the peel will be squeezed out, resulting in a bitter tasting juice.

Furthermore, making use of the citrus juice necessitates, not only the operation in which the citrus fruit that has been cut in half is pushed onto the juicing part and rotated, with the citrus press placed on the table or the like, so that juice collects in the saucer body or bowl body, but also an operation in which the juice that has collected in the saucer body or the bowl body is poured to the desired location, which makes overall operations complicated.

Furthermore, when complicated operations of this sort are performed, even if only a relatively small amount of juice is required, it is difficult to collect a suitably small amount of juice in the saucer body or bowl body, and thus a larger amount of juice than the amount required is generally collected. Consequently, there is a tendency for juice to be wasted.

In light of the situation described above, the present invention meets the following long felt needs.

A first need is that of providing a citrus press that allows citrus juice to be squeezed more easily, with lesser force, than was conventional.

A second need is that of providing a citrus press that allows for simplification of the operations for squeezing and using the citrus juice.

A third need is that of providing a citrus press that allows pomace to be removed easily.

A fourth need is that of providing a citrus press capable of preventing seeds from being mixed in with the juice when the citrus juice is to be used immediately after squeezing.

### SUMMARY OF THE INVENTION

With conventional citrus presses, by pressing the citrus fruit strongly onto the citrus press, the fluid pressure of the juice within the segment membranes of the citrus fruit was increased, so that the segment membranes of the citrus fruit ruptured as a result of the increased fluid pressure, and the citrus juice was squeezed out by way of pressing and rotating the citrus fruit. However, the present inventor has arrived at the idea of cutting or tearing the segment membranes of the citrus fruit with at least the tips of prongs, which are formed into severing parts, instead of increasing the fluid pressure of the juice within the segment membranes of the citrus fruit, so that the segment membranes of the citrus fruit rupture as a result of the increased fluid pressure, so as to produce a remarkable effect that could not have been expected by a person of ordinary skill in the art.

The means for solving the problems constitute the invention set forth in the [claims] of the present application.

Hereafter, an explanation of the terms is provided so as to eliminate questions in terms of the claims, specification, drawings and the like.

### EXPLANATION OF TERMS

The term “citrus press” refers to a juicer that serves to squeeze out juice, by way of slicing a citrus fruit such as a lemon, a lime, a grapefruit, a tangerine, or an orange, and pressing and rotating the cut side of the sliced citrus fruit so as to squeeze out juice.

The term “retaining base” refers to a base serving to arrange a plurality of prongs in an upright manner, which is a constituent member of the citrus press. Here, the term “base” refers to one side of a member having a planar face on which a plurality of prongs are arranged in an upright manner, to the other side to which a handle part is also joined. In the present specification, the retaining base is also referred to simply as the base.

The term “handle part” refers to a part that is gripped by a hand, and which is joined with the retaining base, which is a constituent element of the citrus press.

The term “prong” refers to a rod shaped member, which is a constituent element of the citrus press.

A plurality of prongs are arranged upright on one face of the retaining base. One of the plurality of prongs may be arranged upright in the center of the retaining base (FIG. 1 (a), (b) and FIG. 2 (a), (b)), but it is also possible that no prong be arranged in an upright manner in the center of the retaining base (FIG. 8 (a), (b)).

The term “prong tip” refers to the tip portion of a prong, which serves to sever, which is to say, to cut or to tear, the segment membranes of the citrus fruit.

The term “blade part” refers to a part that serves to cut the segment membranes of the citrus fruit.

The term “point part” refers to a part that serves to tear the segment membranes of the citrus fruit.

The term “seed removal device” refers to a device, at one edge portion on one face of the retaining base, which allows juice to flow freely, while preventing seeds from falling.

The seed removal device according to the present invention may include, for example, a plurality of prongs arranged upright in an arcuate row, at one edge portion, on one face of the retaining base, wherein the gap interval between adjacent prongs must be smaller than the presumed size of the citrus seeds, in order to prevent the seeds from falling (FIG. 6).

The seed removal device according to the present invention may also include, for example, a mesh arranged in an arcuate manner, at one edge portion, on the one face of the retaining base, wherein the gap interval of the mesh must be smaller than the presumed size of the citrus seeds, in order to prevent the seeds from falling (not shown in the drawings).

The term “citrus fruits” is a general term referring to fruits belonging to the subfamily Aurantioideae, also known as Citroideae, of the family Rutaceae in the tribe Citreae, and known more generally as the Citrus family.

The term “segment membrane” refers to the membrane between segments in a citrus fruit, a citrus fruit consisting of approximately 10 radially aligned segments.

The term “pomace removal member” refers to a planar part having holes, through which the plurality of prongs can pass, and which is detachably fitted on one face of the retaining base.

The alignment of the prongs on one face of the retaining base may be such that the prongs are arranged in concentric circles (FIG. 5 (a)), or such that, instead of concentric circles, the prongs are aligned in a spiral form (FIG. 5 (b), or such that the prongs are randomly arranged (not shown in the drawings).

### DETAILED DESCRIPTION OF THE INVENTION

A first aspect of the invention (recited in claim 1) is a citrus press comprising a retaining base and a plurality of prongs arranged upright on one face of the retaining base, wherein a severing part is formed at least at the tip of each prong, for severing segment membranes of a citrus fruit.

A second aspect of the invention (recited in claim 2) is the citrus press described above, wherein the severing part is a blade part or a point part.

A third aspect of the invention (recited in claim 3) is the citrus press described above, wherein among the plurality of prongs, the protruding lengths of the prongs in positions near the center of the retaining base are longer than the protruding lengths of the prongs in positions distant from the center of the retaining base.

A fourth aspect of the invention (recited in claim 4) is the citrus press described above, further comprising a pomace removal member having holes through which the plurality of prongs can pass, which is detachably fitted on one face of the retaining base.

A fifth aspect of the invention (recited in claim 5) is the citrus press described above, further comprising a seed removal device, at one edge portion, on one face of the retaining base, which allows juice to flow freely while preventing seeds from falling.

According to the first aspect of the invention, the citrus press comprises a retaining base and a plurality of prongs arranged upright on one face of the retaining base, wherein a severing part is formed at least at the tip of each prong, for severing segment membranes of a citrus fruit, whereby the first and second needs described above are met, producing a remarkable effect that could not have been expected by a person of ordinary skill in the art.

That is to say, because the citrus press of the present invention comprises a plurality of prongs, the area over which the citrus press of the present invention makes contact with a citrus fruit can be reduced; and because severing part is formed at least at the tip of each prong, for severing segment membranes of the citrus fruit, when juice is squeezed with the citrus press according to the present invention, the resistance to squeezing of the citrus fruit is greatly reduced, these being remarkable effects that could not have been expected by a person of ordinary skill in the art.

According to the second aspect of the present invention, the severing part is a blade part or a point part, whereby the first and second needs described above are met, producing a remarkable effect that could not have been expected by a person of ordinary skill in the art.

That is to say, because the severing part of the present invention is a blade part or a point part, the segment membranes of the citrus fruit can be severed by the blade part or point part of the present invention, when the citrus fruit is squeezed by way of alternatingly rotating the citrus press to the left and the right. Thus, it is possible to alternatingly rotate the citrus press to the left and the right rapidly, with a minimal rotating force, such as can easily be exerted with one hand, whereby juice can be squeezed in less time, and a larger amount of juice can be produced, than with a conventional citrus press, which is highly efficient, producing a remarkable effect that could not have been expected by a person of ordinary skill in the art.

Furthermore, when the citrus press of the present invention is used, there is no need for it to be placed on a table, as was necessary with conventional citrus presses, wherein the need to press with a great force necessitated a table. With the present invention, it is possible to alternatingly rotate the citrus press to the left and the right rapidly, with a minimal rotating force, such as can easily be exerted with one hand, whereby the citrus juice can be drizzled directly over food onto which one wishes to drizzle the citrus juice, thus eliminating the troublesome conventional two-step process in which the juice was first collected, and then the collected juice was drizzled over the food, producing a remarkable effect that could not have been expected by a person of ordinary skill in the art.

According to the third aspect of the present invention, among the plurality of prongs, the protruding lengths of the prongs in positions near the center of the retaining base are longer than the protruding lengths of the prongs in positions distant from the center of the retaining base, whereby the first and second needs described above are met, producing a remarkable effect that could not have been expected by a person of ordinary skill in the art.

According to the fourth aspect of the present invention, the citrus press further comprises a pomace removal member having holes through which the plurality of prongs can pass, which is detachably fitted on one face of the retaining base, whereby the first through third needs described above are met, producing a remarkable effect that could not have been expected by a person of ordinary skill in the art.

That is to say that pomace trapped between the prongs can easily be removed by detaching the pomace removal member from the main body after the citrus fruit has been squeezed, producing a remarkable effect that could not have been expected by a person of ordinary skill in the art.

Furthermore, good hygiene can be maintained, because the pomace removal member that has been detached from the main body can easily be washed, producing a remarkable effect that could not have been expected by a person of ordinary skill in the art.

According to the fifth aspect of the present invention, the citrus press further comprises a seed removal device, at one edge portion, on one face of the retaining base, which allows juice to flow freely while preventing seeds from falling, whereby the first through fourth needs described above are met, producing a remarkable effect that could not have been expected by a person of ordinary skill in the art.

That is to say, if the citrus press of the present invention is used to drizzle juice directly over food, unintentional contamination of the food with citrus seeds can be prevented, producing a remarkable effect that could not have been expected by a person of ordinary skill in the art.

### BRIEF DESCRIPTION OF THE DRAWINGS

FIG. 1 shows a citrus press according to the present invention.

FIG. 1(a) is a front view of the citrus press according to the present invention.

FIG. 1(b) is a plan view of the citrus press according to the present invention.

FIG. 2 shows the citrus press according to the present invention on which the pomace removal member has been fitted.

FIG. 2(a) is a front view of the citrus press according to the present invention on which the pomace removal member has been fitted.

FIG. 2(b) is a plan view of the citrus press according to the present invention on which the pomace removal member has been fitted.

FIG. 3 shows the pomace removal member according to the present invention.

FIG. 3(a) is a front view of the pomace removal member according to the present invention.

FIG. 3(b) is a plan view of the pomace removal member according to the present invention.

FIG. 4 shows a blade part C1 and point parts C2 of a plurality of severing parts of the citrus press according to the present invention.

FIG. 4(a) and (b) show point parts C2 of a plurality of severing parts of the citrus press according to the present invention.

FIG. 4(c) shows a blade part C1 of a plurality of severing parts of the citrus press according to the present invention.

FIG. 5 shows alignments for the plurality of prongs of the citrus press according to the present invention.

FIG. 6 shows a citrus press according to the present invention, which is provided with a seed removal device.

FIG. 7 illustrates a manner in which a citrus press according to the present invention can be used.

FIG. 8 shows another embodiment of a citrus press according to the present invention.

FIG. 8(a) is a front view of the citrus press according to this embodiment of the present invention.

FIG. 8(b) is a plan view of the citrus press according to this embodiment of the present invention.

### PREFERRED MODES OF EMBODIMENT OF THE INVENTION

Hereafter, preferred modes of embodiment for the citrus press according to the present invention are described with reference to the drawings.

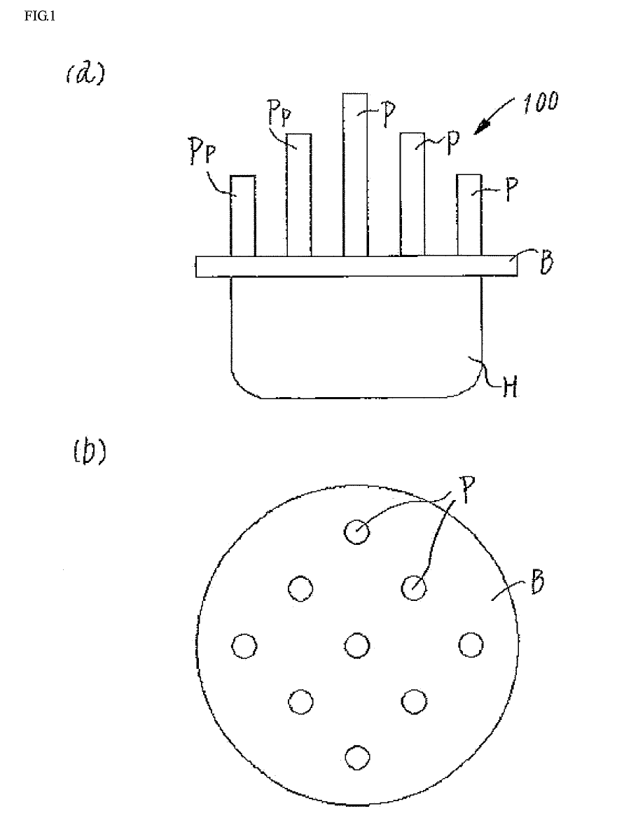

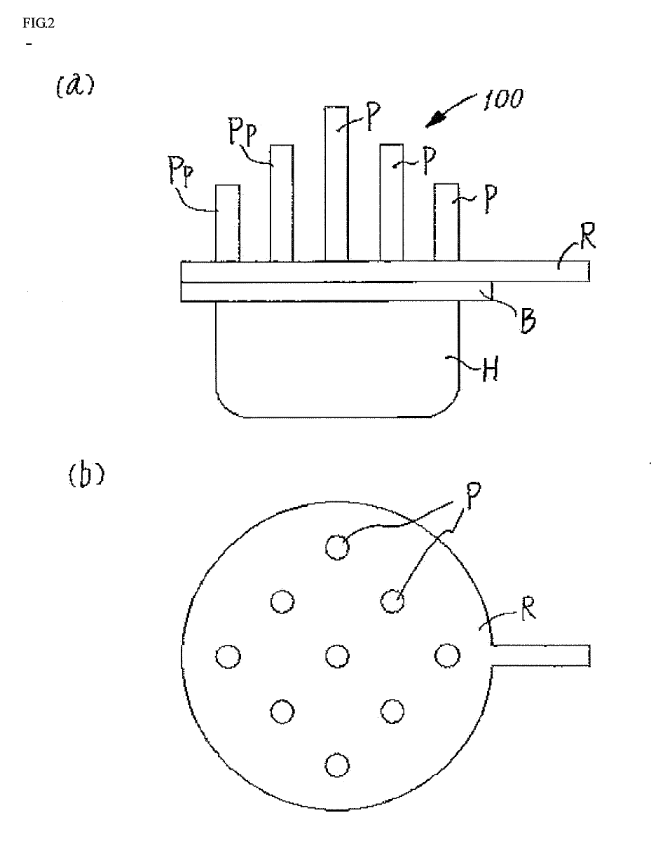

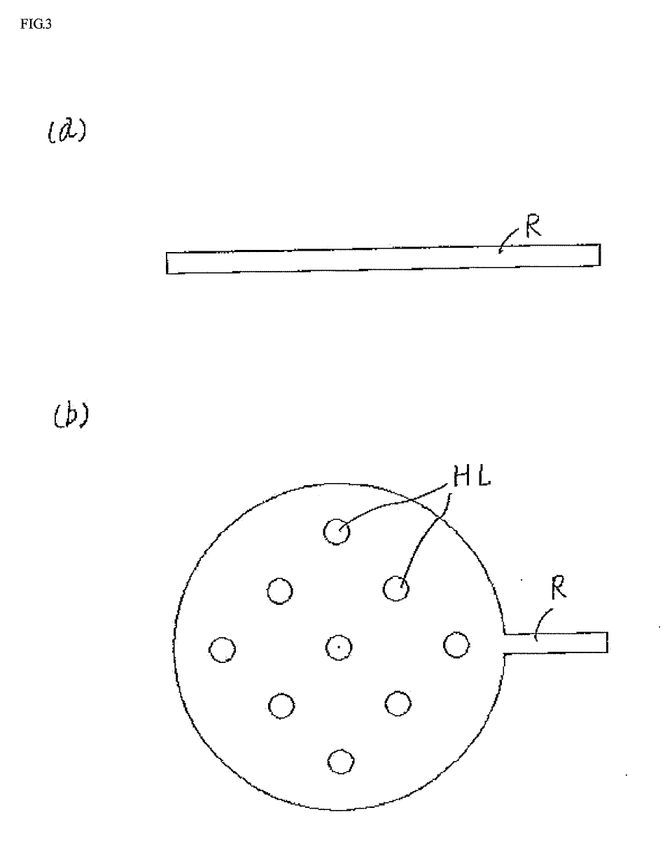

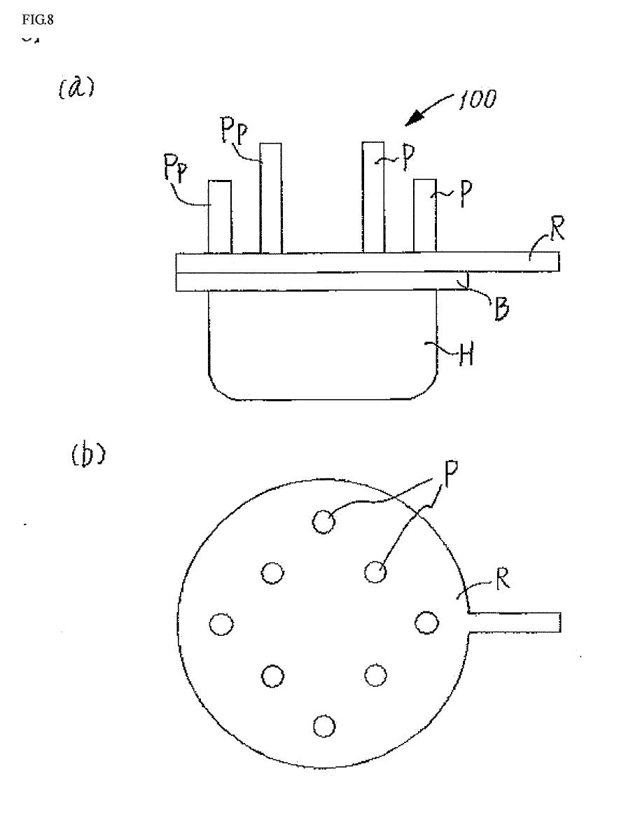

A citrus press 100 is disclosed, comprising a retaining base B and a plurality of prongs P arranged upright on one face of the retaining base B, wherein a severing part is formed at least at the tip Pp of each prong P, for severing segment membranes of a citrus fruit (FIG. 1 (a), (b); FIG. 2 (a), (b); and FIG. 8 (a), (b)).

According to the preferred mode of embodiment described above (first aspect of the invention), the citrus press comprises a retaining base B and a plurality of prongs P arranged upright on one face of the retaining base B, wherein a severing part is formed at least at the tip Pp of each prong P, for severing segment membranes of citrus fruit, whereby the first and second needs described above are met, producing a remarkable effect that could not have been expected by a person of ordinary skill in the art.

That is to say, because the citrus press 100 of the present invention comprises a plurality of prongs P, the area over which the citrus press 100 of the present invention makes contact with the citrus fruit can be reduced; and because severing part is formed at least at the tip Pp of each prong P, for severing segment membranes of the citrus fruit, when juice is squeezed with the citrus press 100 according to the present invention, the resistance to squeezing of the citrus fruit is greatly reduced, these being remarkable effects that could not have been expected by a person of ordinary skill in the art.

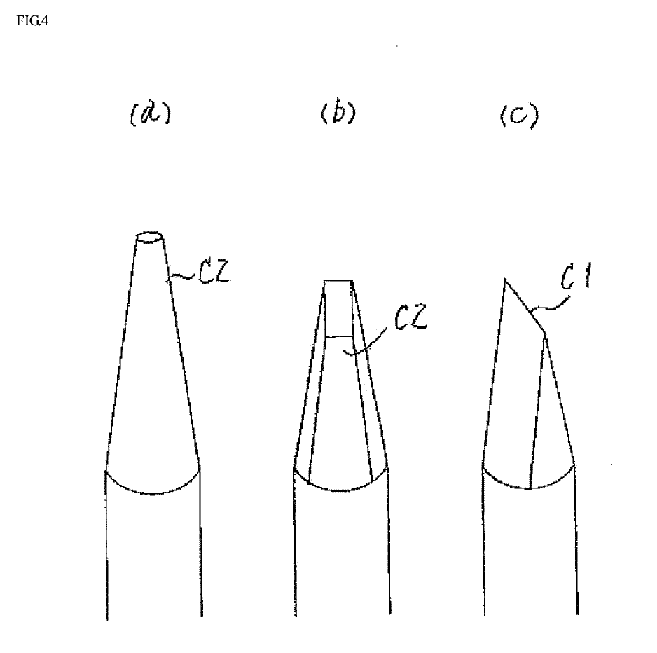

A citrus press 100 is disclosed, wherein the severing part is a blade part C1 or a point part C2 (FIG. 1 (a), (b); FIG. 2 (a), (b); FIG. 8 (a), (b); and FIG. 4).

According to the preferred mode of embodiment described above (second aspect of the invention), the severing part is a blade part C1 or a point part C2, whereby the first and second needs described above are met, producing a remarkable effect that could not have been expected by a person of ordinary skill in the art.

That is to say, because the severing part is a blade part C1 or a point part C2, the segment membranes of the citrus fruit can be severed by the blade part C1 or point part C2 when the citrus fruit is squeezed by way of alternatingly rotating the citrus press to the left and the right. Thus, it is possible to alternatingly rotate the citrus press to the left and the right rapidly, with a minimal rotating force, such as can easily be exerted with one hand, whereby the juice can be squeezed in less time, and a larger amount of juice can be produced, than a conventional citrus press 100, which is highly efficient, producing a remarkable effect that could not have been expected by a person of ordinary skill in the art.

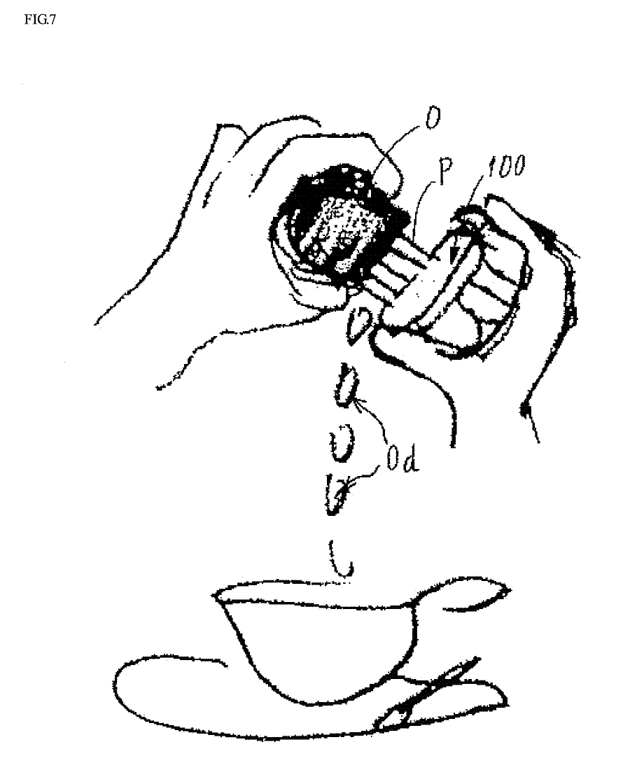

Furthermore, when the citrus press 100 of the present invention is used, there is no need for this to be placed on a table, as was necessary with conventional citrus presses wherein the need to press with a great force necessitated a table. With the present invention, it is possible to alternatingly rotate the citrus press to the left and the right rapidly, with a minimal rotating force, such as can easily be exerted with one hand, whereby the citrus juice can be drizzled directly over food onto which one wishes to drizzle the citrus juice, thus eliminating the troublesome conventional two-step process in which the juice was first collected, and then the collected juice was drizzled over the food, producing a remarkable effect that could not have been expected by a person of ordinary skill in the art (FIG. 7).

A citrus press 100 is disclosed, wherein, among the plurality of prongs P, the protruding lengths of the prongs P in positions near the center of the retaining base B are longer than the protruding lengths of the prongs P in positions distant from the center of the retaining base B (FIG. 1 (a), (b); FIG. 2 (a), (b); and FIG. 8 (a), (b)).

A plurality of prongs P are arranged upright on one face of the retaining base B and, from among the plurality of prongs P, one prong P may be arranged upright in the center of the retaining base B (FIG. 1 (a), (b) and FIG. 2 (a), (b)), but it is also possible that no prong P be arranged in an upright manner in the center of the retaining base B (FIG. 8 (a), (b)).

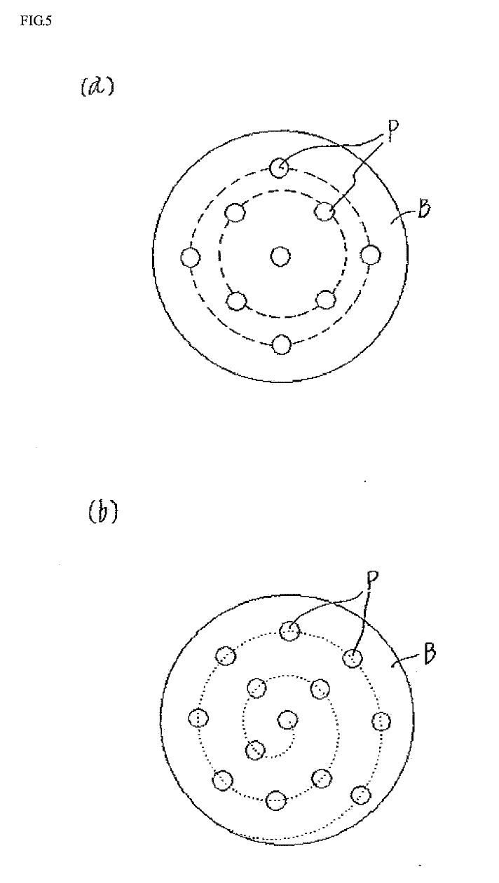

The alignment of the prongs P, on one face of the retaining base B, may be such that the prongs P are arranged in concentric circles (FIG. 5 (a)), or such that, instead of in concentric circles, the prongs P are aligned in a spiral form (FIG. 5 (b)), or such that the prongs P are randomly arranged (not shown in the drawings).

According to the preferred mode of embodiment described above (third aspect of the invention), among the plurality of prongs P, the protruding lengths of the prongs P in positions near the center of the retaining base B are longer than the protruding lengths of the prongs P in positions distant from the center of the retaining base B, whereby the first and second needs described above are met, producing a remarkable effect that could not have been expected by a person of ordinary skill in the art.

A citrus press 100 is disclosed, wherein the citrus press 100 further comprises a pomace removal member R having holes HL through which the plurality of prongs P can pass, which is detachably fitted on one face of the retaining base B (FIG. 2 (a), (b)).

According to the preferred mode of embodiment described above (fourth aspect of the invention), the citrus press 100 further comprises a pomace removal member R having holes HL through which the plurality of prongs P can pass, which is detachably fitted on one face of the retaining base B, whereby the first through third needs described above are met, producing a remarkable effect that could not have been expected by a person of ordinary skill in the art.

That is to say that pomace trapped between the prongs P can easily be removed by detaching the pomace removal member R from the main body after the citrus fruit has been squeezed, producing a remarkable effect that could not have been expected by a person of ordinary skill in the art.

Furthermore, good hygiene can be maintained because the pomace removal member R that has been detached from the main body can easily be washed, producing a remarkable effect that could not have been expected by a person of ordinary skill in the art.

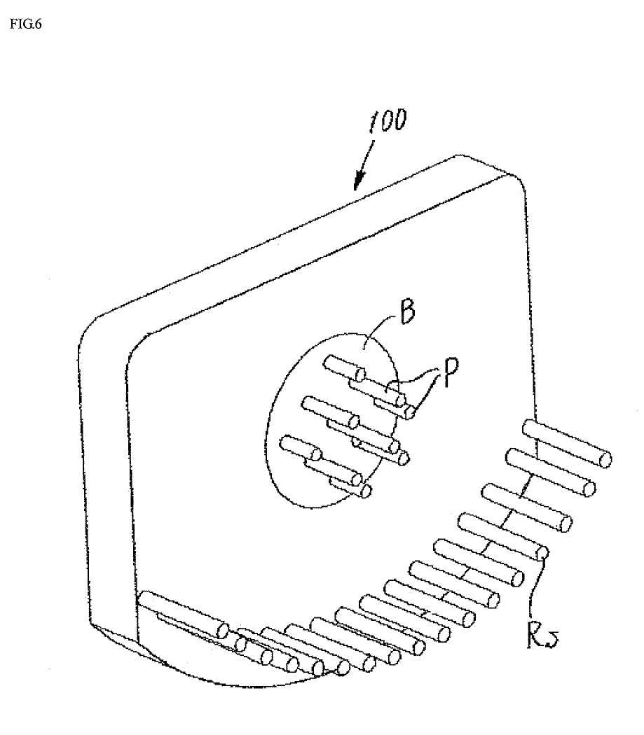

A citrus press 100 is disclosed, wherein the citrus press 100 further comprises a seed removal device Rs at one edge portion on one face of the retaining base B, which allows juice to flow freely while preventing seeds from falling (FIG. 6).

According to the preferred mode of embodiment described above (fifth aspect of the invention), the citrus press 100 further comprises a seed removal device Rs, at one edge portion on one face of the retaining base B, which allows juice to flow freely while preventing seeds from falling, whereby the first through fourth needs described above are met, producing a remarkable effect that could not have been expected by a person of ordinary skill in the art.

That is to say, when the citrus press 100 of the present invention is used to drizzle juice directly over food, unintentional contamination of the food with citrus seeds can be prevented, producing a remarkable effect that could not have been expected by a person of ordinary skill in the art (FIG. 7).

1. A citrus press comprising a retaining base and a plurality of prongs arranged upright on one face of the retaining base, wherein a severing part is formed at least at the tip of each prong, for severing segment membranes of a citrus fruit.

2. The citrus press according to claim 1, wherein the severing part is selected from the group consisting of a blade part and a point part.

3. The citrus press according to claim 1, wherein among the plurality of prongs, the protruding lengths of the prongs in positions near the center of the retaining base are longer than the protruding lengths of the prongs in positions distant from the center of the retaining base.

4. The citrus press according to claim 1, further comprising a pomace removal member having holes through which the plurality of prongs can pass, which is detachably fitted on one face of the retaining base.

5. The citrus press according to claim 1, further comprising a seed removal device, at one edge portion on one face of the retaining base, which allows juice to flow freely while preventing seeds from falling.

6. The citrus press according to claim 2, wherein among the plurality of prongs, the protruding lengths of the prongs in positions near the center of the retaining base are longer than the protruding lengths of the prongs in positions distant from the center of the retaining base.

7. The citrus press according to claim 2, further comprising a pomace removal member having holes through which the plurality of prongs can pass, which is detachably fitted on one face of the retaining base.

8. The citrus press according to claim 3, further comprising a pomace removal member having holes through which the plurality of prongs can pass, which is detachably fitted on one face of the retaining base.

9. The citrus press according to claim 2, further comprising a seed removal device, at one edge portion on one face of the retaining base, which allows juice to flow freely while preventing seeds from falling.

10. The citrus press according to claim 3, further comprising a seed removal device, at one edge portion on one face of the retaining base, which allows juice to flow freely while preventing seeds from falling.

11. The citrus press according to claim 4, further comprising a seed removal device, at one edge portion on one face of the retaining base, which allows juice to flow freely while preventing seeds from falling.
